(19) United States
(12) Patent Application Publication
(10) Pub. No.: US 2011/0099401 A1
(43) Pub. Date: Apr. 28, 2011

(54) Microcontroller system

(76) Inventors: Claus Steinle, Stuttgart (DE); Holger Ceskutti, Moeckmuehl (DE); Martin Thomas, Kraichtal (DE)

(21) Appl. No.: 11/666,784

(22) PCT Filed: Oct. 26, 2005
(86) PCT No.: PCT/EP05/55558

§ 371 Date: Nov. 3, 2008

(30) Foreign Application Priority Data
Nov. 3, 2004 (DE) 102004053159.5

(51) Int. Cl. G06F 1/32

(52) U.S. Cl. 713/323; 713/320

(57) ABSTRACT

A microcontroller system includes a microcontroller, which is able to be switched over between a state having high power consumption and a state having restricted power consumption, a status register, a timer and a first logic assembly that is connected to the timer and the status register, and, in response to receiving a time-out signal from the timer, causes a transition of the microcontroller from the state of restricted power consumption to the state of high power consumption, if the content of the status register has a first specified value.

### FIELD OF THE INVENTION

The present invention relates to a microcontroller system having a microcontroller which is able to be switched over between an operating state having high power consumption and an operating state having restricted power consumption. In the state of restricted power consumption, the functions of the microcontroller, that are available in the state of high power consumption, are not available or available only in restricted fashion. Such microcontrollers have been developed for applications in which phases, in which the microcontroller is greatly loaded, alternate with phases in which the microcontroller is inactive or slightly loaded. The average power consumption of the microcontroller system is able to be considerably reduced by switching the microcontroller into the state of restricted power consumption in the inactivity phases, which is especially of advantage in applications having current supply independent of networks.

However, no matter how low the restricted power consumption of the microcontroller is, there is the problem that the operation of the microcontroller may sooner or later exhaust a current source, having limited capacity, that is independent of a network. If, for instance, the microcontroller system is installed in a motor vehicle and fed from its battery, the battery will be exhausted after more or less time, the result being that the vehicle can no longer be started without external auxiliary means. In order to reduce this danger, the total energy consumption of the microcontroller system has to be made as low as possible during an interval in which the full processing capacity of the microcontroller is not needed, such as when the vehicle is standing.

### BACKGROUND OF THE INVENTION

A microcontroller system is created by the present invention which is sufficient for this requirement. It includes a microcontroller which is able to be switched over between a state having high power consumption and a state having restricted power consumption, a status register, a timer and a first logic gate that is connected to the timer and the status register, and in response to receiving a time-out signal from the timer, causes a transition of the microcontroller from the state of restricted power consumption to the state of high power consumption, if the content of the status register has a first specified value. As soon as the status register loses this specified value, either because it is overwritten by the microcontroller or by the access of any other circuit element, the microcontroller system will no longer return into the state of high power consumption.

Preferably, the microcontroller will be completely switched off if the content of the status register has been changed to a second value in response to receiving the time-out signal.

### SUMMARY OF THE INVENTION

The microcontroller is expediently devised to carry out a transition from the state of high power consumption to the state of restricted power consumption under control of its own operating program. This makes possible an automatic return of the microcontroller to the state of restricted power consumption after it has transited to the state of high power consumption caused by the time-out signal.

Preferably, only in the state of high power consumption is the microcontroller in a position to execute program instructions, but not in the state of restricted power consumption.

On the other hand, contents of registers of the microcontroller are expediently retained in the state of restricted power consumption, so that, in response to the transition into the state of high power consumption, the data previously stored in the microcontroller are immediately available to it.

The status register should preferably be able to be written on by the microcontroller. In that way, the microcontroller, when it is in the state of high power consumption, has the opportunity at any time to determine, with the aid of current operating conditions, whether this state is to be reproduced or not, after a temporary transition into the state of restricted power consumption.

Alternatively or in addition, it may also be provided that a monitoring circuit, for measuring the residual capacitance of an energy source feeding the microcontroller system, overwrites the status register if the residual capacitance of the energy source falls below a critical value, and thus prevents a return into the state of high power consumption if this could lead to an excessive exhaustion of the energy source.

The timer generates the time-out signal, preferably at a specified delay after a transition of the microcontroller from the state of high power consumption into the state of restricted power consumption, so that, as long as the register contains the first value, the microcontroller returns cyclically to the state of restricted power consumption after the expiration of the set delay.

The value of the delay may be adjusted by the microcontroller. The microcontroller and the timer are preferably implemented in a common circuit component.

If the microcontroller includes a voltage supply circuit which is designed to supply a set of a plurality of supply potentials, of which not all are required in the state of restricted power consumption of the microcontroller, this voltage supply circuit is preferably able to be switched over between a state in which it supplies the complete set of supply potentials and a state in which it does not supply at least one of the supply potentials that are not required for the operation of the microcontroller in the state of restricted power consumption. In this way, the power loss of the voltage supply circuit is able to be reduced in times of restricted power consumption of the microcontroller, and thereby the service life of a battery can be further prolonged.

A logic gate is preferably connected in series with a reset input which, in the state of restricted power consumption, does not transmit reset commands to the microcontroller. Such a logic gate is particularly expedient in suppressing reset commands which are always generated by an operating voltage monitoring circuit, known per se, if an operating voltage monitored by it leaves an admissible interval, which, in a state of high power consumption, could lead to a malfunction of the microcontroller,

Further features and advantages of the present invention result from the following description of an exemplary embodiment, with reference to the enclosed FIGURE.

### BRIEF DESCRIPTION OF THE DRAWING

FIG. 1 shows a block diagram of the microcontroller system according to the present invention.

### DETAILED DESCRIPTION

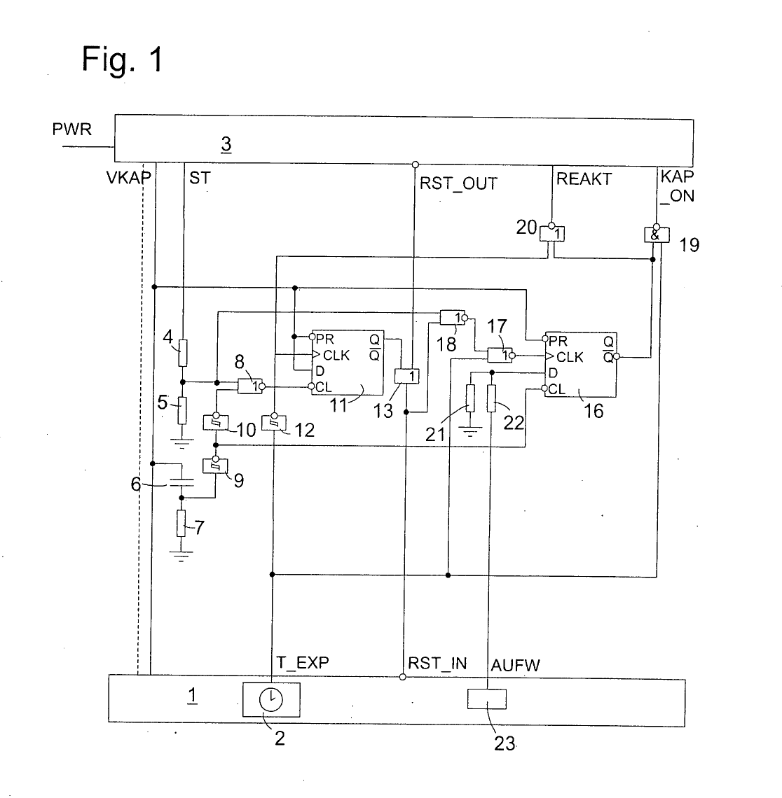

The microcontroller system shown in FIG. 1 includes a microcontroller 1 which is able to be switched over from a normal operating state having high power consumption, in which it is in a position of reading and executing an operating program stored in a memory (not shown in the FIGURE), into a state having restricted power consumption, in which it is no longer in a position of processing the operating program, but in which the contents of the registers of the microcontroller, or at least a part of these registers, as well as a write-read memory (also not shown), which microcontroller 1 accesses, are retained, and an internal timer 2 of the microcontroller remains operative. Microcontroller 1 obtains a plurality of supply potentials from an integrated voltage supply component 3, also known, for short, as voltage supply 3. Of the plurality of potentials made available by voltage supply 3, only one, designated in the FIGURE as VKAP, is required for maintaining the state of restricted power consumption of microcontroller 1. Potential VKAP amounts, for instance, to ca. 2.6 V. Supply lines required for supply potentials only in the state of high power consumption of microcontroller 1 are shown symbolically in the FIGURE as a dashed line between voltage supply 3 and microcontroller 1.

A plurality of logical components 8 through 20, which will be described more accurately below, would only require supply potential VKAP for their operation.

The microcontroller system receives from the outside an on/off switching signal PWR which, if the microcontroller system is installed in a motor vehicle, can be derived, for example, from its ignition, and in response to a switched-off ignition assumes a ground level corresponding to a logical value zero, and in response to a switched-on ignition assumes, for instance, a potential of +12 V, corresponding to a logical one. The on/off switching signal PWR is directly present at a switching input of voltage supply 3. In accordance with the level of the on/off switching signal, the voltage supply supplies a status signal ST, having a level of 5 or 0 V. Status signal ST is applied via a voltage divider of resistors 4, 5, which reduces the 5V level to 2.6 V, to a first input of a NOR-gate 8. The second input of NOR-gate 8 is connected to VKAP via a low-pass filter, made up of a capacitor 6 and a resistor 7, and two inverting Schmitt triggers 9, 10 that are connected one after the other. The output of NOR-gate 8 is connected to a low active reset input CL of a first delay flipflop 11.

Flipflop 11 also has a high active set input PR that is directly connected to VKAP, a clock input CLK which receives an inverted time-out signal T_EXP, inverted by an inverting Schmitt trigger 12, from timer 2, and a data input D that is directly connected to VKAP. At a non-inverting data output Q of flipflop 11, a first input of an OR-gate 13 is connected, whose second input is connected to a reset output RST_OUT of voltage supply 3, and whose output is connected to a reset input RST_IN of microcontroller 1.

A second D flipflop 16 is identical with flipflop 11. Data input D of flipflop 16 is connected to a wake-up request signal AUFW of microcontroller 1, which is brought down via a voltage divider made up of resistors 21, 22 from the usual TTL output level of 5 V of the microcontroller to 2.6 V corresponding to the supply potential VKAP of flipflop 16. The clock signal at input CLK of flipflop 16 originates from a NAND-gate 17, which receives at its first input the timer time-out signal T_EXP and at its second input the output signal of an additional NAND-gate 18. To the inputs of NAND-gate 18, in turn, there are connected the output of OR-gate 13 and the output of voltage divider 4, 5.

The inverted output signal Q̅ of flipflop 16 is present at a control input KAP_ON, linked via a NAND-gate 19 to timer time-out signal T_EXP, and at a control input REAKT of voltage supply 3, linked via a NOR-gate 20 to the inverted time lapse signal of Schmitt trigger 12.

The method of operation of the circuit is explained in the following. In this context, a state is assumed as initial state in which voltage supply 3 supplies no voltage potential whatsoever and on/off switching signal PWR has the value logical zero, that is, the microcontroller system is completely switched off. When the vehicle ignition is operated, and accordingly PWR has transited in a stable manner to logical one, voltage supply 3 begins to output the diverse supply potentials of microcontroller 1 and status signal ST at a high level. As long as the supply potentials are not stable, reset output RST_OUT of voltage supply 3 is held to zero.

Via voltage dividers 4, 5, 2.6 V derived from status signal ST, corresponding to a level of logical one, are present at an input of NOR-gate 8, so that NOR-gate 8, independently from its other input signal, supplies an output signal of level logical zero to low active reset input CL of flipflop 11. At output Q of flipflop 11 the value appears as logical zero, so that OR-gate 13 supplies the value logical zero to reset input RST_IN of microcontroller 1. Thus, the microcontroller is continually reset in this phase.

As soon as the supply voltages supplied by voltage supply 3 are stable, reset output RST_OUT changes to logical one. Since the content of flipflop 11 does not change meanwhile, level logical one also reaches reset input RST_IN of microcontroller 1, so that it is no longer reset and is able to begin processing its operating program.

In the starting phase, the operating program checks for certain registers and RAM memory regions whether these contain data retained from an earlier operating phase of microcontroller 1, or whether they contain coincidental values created only by the switching on. The type of checking depends on how these data were safeguarded in the preceding operating phase by the operating program.

One possibility of undertaking this checking is, for instance, to reserve one among a plurality of registers or RAM storage cells, which is described using parity bits or another type of integrity check information of the other registers or storage cells. In the starting phase, the microcontroller computes the integrity check information for the other registers or memory cells anew, and compares the result with the content of the one register or the one cell. In the situation considered here of the restart after the complete switching off, the integrity check information that was calculated and the one found in the one register or the one storage cell do not agree. The memory contents are thus without value and have to be initialized anew. When there is agreement, the memory contents represent usable data, with a probability of 1-2ⁿ (if n is the bit number of the integrity check information).

Another possibility of safeguarding data that are to be retained is to store of each datum to be safeguarded not only its actual value but also its bit-wise negation, and to check these in response to a restart.

When the ignition is switched off again, PWR returns to logical zero. Voltage supply 3 stops the generation of all supply voltages with the exception of VKAP. Microcontroller 1 decides with the aid of its operating program whether it may be completely switched off, or whether it is to be activated once more at a later point in time, and, depending on this decision, sets an internal register 23 to logical zero or logical one, whose content is output at a terminal of microcontroller 1 as an output signal AUFW designated as a “wake-up request signal”.

Whenever one of the plurality of supply potentials of voltage supply 3 is not available in such a way that it ensures a functioning of microcontroller 1 according to the rules, and especially also when voltage supply 3 supplies only VKAP, its output RST_OUT goes to logical zero. Usually this is supposed to ensure that a microcontroller fed by voltage supply 3 does not get into an undefined state, based on a supply voltage fault, but is started again each time the danger of such a state threatens. Such a restart is, however, undesired if the microcontroller goes over into the state of restricted power consumption only intermittently. In this state, the restart is suppressed here, because the signal at reset input CL of flipflop 11 transits to one, as soon as capacitor 6 is charged, that is, flipflop 11 is no longer constantly reset but, triggered by timer time-out signal TEXP in response to switching off the ignition, is able to store the value one at its data input and as a result is able to output it at output Q. The value Q=1 is also present at low reactive reset input RST_IN of microcontroller 1 via OR-gate 13, so that microcontroller 1 is not reset in the state of restricted power consumption.

Let us first look at the case where the microprocessor does not have to be put in operation again after transition of PWR to zero. In this case AUFW is set to zero, and timer output T_EXP transits from one to zero. From this, there results in each case a rising slope at clock inputs CLK of flipflops 11, 16, which causes these to take over the value present at their respective data input D. In the case of flipflop 11, this is the value one, since voltage supply 3 still supplies supply voltage VKAP. In the case of flipflop 16 it is the value zero of wake-up request signal AUFW.

Microcontroller 1 initializes timer 2 at a specified delay time, gets it going and transits into the state of restricted power consumption. As long as the timer has not given the time-out signal, NOR-gate 19 receives from the timer T_EXP=0 and from flipflop 16 Q̅=1, and consequently applies level logical one to input. PAP_ON of voltage supply 3, so that the latter continues to supply output voltage VKAP.

When the timer runs down, T_EXP assumes the value one, so that NOR-gate 19 applies zero levels at input KAP_ON, (since Q̅=1). As a result, after the time-out of timer 2, voltage supply 3 also stops generating supply voltage VKAP, and the microcontroller system is completely switched off.

Let us now look at the case where, after the ignition is switched off, microcontroller 1 decides to transit once more into the state of increased power consumption, in which it is operable without restriction. In this case microcontroller 1 sets internal register 23, and along with that wake-up request signal AUFW to the value one before it goes over into the state of restricted power consumption, and T_EXP goes to zero, and as a result, the value one is stored in flipflop 16. Now, when timer 2 gives the time-out signal and output T_EXP assumes the value one again, a one is also present at the other input of NOR-gate 19, so that NOR-gate 19 continuously supplies level 1 at input KAP_ON of voltage supply 3. Thus, the generation of VKAP is not ceased upon time-out of timer 2.

Before the time-out of timer 2, NOR-gate 20 receives the value zero from output Q̅ of flipflop 16 and the value one from inverting Schmitt trigger 12 that is connected to T_EXP, and supplies zero level to a reactivating input REAKT of voltage supply 3. Upon time-out of the timer, output signal of Schmitt trigger 12 goes to zero, and with that, the output signal of NOR-gate 20 goes to one. Voltage supply 3 is reactivated thereby, and also takes up again the generation of all other supply voltages besides VKAP.

As in the case of the initial operation of the microcontroller system, described above, from the completely switched-off state, voltage supply 3 holds reset output RST_OUT to zero as long as the supply voltages are not yet stable again. With the switching on again, ST goes to the high level again. Thereby flipflop 11 is reset to zero, and draws via OR-gate 13 reset input RST_IN of microcontroller 1 on level logical zero. This forces a resetting of microcontroller 1. The latter now starts its operating program anew, using the memory contents and register contents that have remained unchanged since the switching off.

As in the case examined before, of the start after prior complete switching off, the operating program includes checking the memory contents and register contents for integrity. This time, these contents are recognized as usable and are not initialized.

When microcontroller 1 has finished the tasks to be executed, it decides anew whether it has to be activated once more or may finally be switched off, and accordingly it sets the value of wake-up request signal AUFW, sets T_EXP to zero in order to trigger flipflop 11, 16, starts timer 2 and causes voltage supply 3 to cease the generation of all supply voltages except VKAP.

When microcontroller 1 is in the state of restricted power consumption, it is also possible at any time to reproduce the full operating capability of the microcontroller system by operating the ignition of the vehicle.

A simple example of an application of the above-described microcontroller system is the measuring of the off-duration of the vehicle ignition in a vehicle having an exhaust gas catalytic converter. To do this, a volatile memory is initialized unequal to zero while PWR=1. While the ignition is switched off and PWR=0, the memory is decremented in response to each transition into the state of high power consumption. When the ignition is switched on again, and when PWR=1 again and the register is zero, one must assume that the catalytic converter is cold. If the register is different from zero, it tells the operating time of the vehicle, and with the aid of the operating time one is able to estimate the temperature of the catalytic converter and how to run it in optimal fashion.

1-13. (canceled)

14. A microcontroller system, comprising:
a microcontroller able to be switched over between a state having high power consumption and a state having restricted power consumption;
a status register;
a timer;
a first logic assembly that is connected to the timer and the status register, and, in response to receiving a time-out signal from the timer, causes a transition of the microcontroller from the state of restricted power consumption to the state of high power consumption, if the content of the status register has a first specified value.

15. The microcontroller system as recited in claim 14, wherein the first logic assembly, upon receipt of the time-out signal from the timer, causes the switching off of the microcontroller, if the content of the status register has a second specified value.

16. The microcontroller system as recited in claim 14, wherein the microcontroller is equipped to carry out a transition from the state of high power consumption to the state of restricted power consumption, in a manner controlled by a program.

17. The microcontroller system as recited in claim 14, wherein the state of high power consumption is a state in which the microcontroller is in a position to execute program instructions; and the state of restricted power consumption is a state in which the microcontroller is not in a position to execute program instructions.

18. The microcontroller system as recited in claim 14, wherein the contents of the registers of the microcontroller are retained in the state of restricted power consumption.

19. The microcontroller system as recited in claim 14, wherein the status register is able to be written upon by the microcontroller.

20. The microcontroller system as recited in claim 14, wherein the timer generates the time-out signal at a specified delay after a transition from the state of high power consumption of the microcontroller to the state of restricted power consumption.

21. The microcontroller system as recited in claim 20, wherein the delay is able to be adjusted by the microcontroller.

22. The microcontroller system as recited in claim 14, wherein the microcontroller and the timer are implemented in a common circuit component.

23. The microcontroller system as recited in claim 14, further comprising a voltage supply circuit that supplies a set of a plurality of supply voltages, and which is able to be switched over between a state in which it supplies the entire set and a state in which it does not supply at least one supply potential of the set, which is not required for the operation of the microcontroller in the state of restricted power consumption.

24. The microcontroller system as recited in claim 23, wherein a control input of the voltage supply circuit is connected to the status register, and the voltage supply circuit supplies the incomplete set of output voltages exactly when the content of the status register has the first specified value.

25. The microcontroller system as recited in claim 14, further comprising:
a logic gate connected in series with a reset input of the microcontroller which does not transmit reset commands to the microcontroller in the state of restricted power consumption.

26. The microcontroller system as recited in claim 14, wherein the microcontroller system is a control unit for a motor vehicle.
